(19) United States
(12) Patent Application Publication
(10) Pub. No.: US 2016/0017082 A1
(43) Pub. Date: Jan. 21, 2016

(54) Plasticizer Having Cationic Side Chains

(71) Applicant: SIKA TECHNOLOGY AG, Baar (CH)

(72) Inventors: Christina HAMPEL, Rütihof (CH); Jörg ZIMMERMANN, Winterthur (CH); Jabbar AL SHEMARI, Zürich (CH); Markus FRIEDERICH, Kilchberg (CH)

(73) Assignee: SIKA TECHNOLOGY AG, Baar (CH)

(21) Appl. No.: 14/649,313

(22) PCT Filed: Dec. 16, 2013
(86) PCT No.: PCT/EP2013/076715

§ 371 Date: Jun. 3, 2015

(30) Foreign Application Priority Data
Jan. 7, 2013 (EP) 13150423.5

(51) Int. Cl. C08F 290/06; C04B 24/26

(52) U.S. Cl. CPC C08F 290/062; C04B 24/2652

(57) ABSTRACT

Provided are cationic comb polymers, obtainable by polymerizing a monomer mixture, which contains at least one monomer having at least one cationic group covalently bonded to the monomer and which contains at least one monomer of the formula R¹—O-[AO]ₙ—R², wherein R¹ is an alkenyl group, R² represents H, an alkyl group having 1 to 20 C atoms, or an aryl group or alkylaryl group having 7 to 20 C atoms, A independently of one another represents a C₂ to C₆ alkylene group, and n is a value from 2 to 300. Also provided are hydraulically setting cement compositions, shaped bodies, uses, and methods for producing comb polymers. Also provided are novel comb polymers with cationic side chains and structural subunits that comprise polyether components. Further provided are hydraulically setting cement compositions, shaped bodies, uses and methods for producing comb polymers.

### PRIOR ART

In construction technology, when processing hydraulically setting compositions such as cement and gypsum, dispersing agents are added, which function in particular as plasticizer. By the addition of such plasticizers, the water content can be lowered, whereby the workability of the paste-like compositions is improved, and the stability of the cured products is increased. An important group of such dispersing agents are comb polymers of polycarboxylic acids with polyalkylene glycol side chains (polycarboxylate ether, PCE). They are known as comb polymers, because they have a single base polymer (“backbone”) to which a plurality of side chains is covalently linked such that the molecular structure overall is similar to a comb. There are a variety of such comb polymers, which, in addition to ester groups and free carboxyl groups, also may comprise amide groups.

Gypsum is an important building material that is used for a variety of applications. Curable gypsum compositions are used for example for producing gypsum board, as putties, plasters or for the production of screeds. In the processing of gypsum there is a need to reduce the water content. Thereby, the set gypsum becomes less porous and therefore more stable. Also, at lower water content a shorter drying process is sufficient, whereby the processing is speeded up and energy can be saved. Hydraulically setting binders from natural deposits, such as gypsum, often exhibit a clay content. However, conventional comb polymers are not or only partially effective as a dispersing agent when a hydraulically setting composition contains clay. Comb polymers interact in clay-containing gypsum compositions undesirably with clay particles and therefore cannot achieve the desired effect.

To solve the problem it is proposed in the prior art, to add additives which compensate the negative effects of clay, or which specifically in clay-containing compositions achieve dispersing and plasticizing action.

U.S. Pat. No. 7,261,772 B1 describes a gypsum composition which, in addition to water, gypsum and clay, also contains polyoxyalkylenes, an amine compound and a comb polymer. The use of volatile amines is disadvantageous, however, since they lead to unpleasant odors and are harmful to health during processing and release from cured products. In many applications, in particular gypsum boards, these drawbacks are not acceptable for users.

WO 98/58887 proposes to add additional additives, namely polyethers based on ethylene oxide and propylene oxide, and low molecular weight cationic compounds to clay-containing cement compositions. A disadvantage is the relatively low effectiveness of the additives and the high proportion of low molecular weight substances, which themselves are not effective as plasticizer, however, decrease the stability of the cured product.

US 2007/0287794 A1 discloses to add cationic polymers to clay-containing gypsum compositions. The polymers are condensates of primary and secondary amines with suitable reactants such as epichlorohydrin. In this case the reaction products are linear polymers bearing cationic charges on the polymer main chain. The disadvantage here is that in producing such condensates compounds are used, which are chemically not easy to handle and sometimes harmful to health, such as amines, epoxides and cyanide compounds.

EP 2 463 317 A1 proposes to add plasticizing polycarboxylate ethers having additional side chains with cationic groups to clay-containing gypsum compositions. The problem is, however, that the comb polymers are relatively complex. The exemplary embodiments of EP 2 463 317 A1 show that the cationic polymers can improve the flowability of gypsum compositions. However, the setting time remains almost unchanged.

WO2008/049549 discloses cationic polycarboxylate ethers, which also have polyalkylene glycol side chains linked via ester groups. The exemplary embodiments of WO2008/049549 show, however, that the cationic polymers have little or no influence on the flowability compared to comparative experiments.

US 2012/0231991 A1 discloses comb polymers as additives for cleaning agents based on amphoteric polycarboxylates. The comb polymers contain cationic groups on the side chains, which are connected to the main chain via polyether groups.

EP 2 325 231 A1 relates to comb polymers as additives for cement compositions having in particular thiol groups. The comb polymers contain polyalkylene glycol side chains which may be connected to the main chain via ether groups (paragraph [0055], formula 5). In addition, for producing the comb polymers conventional monomers having anionic groups, namely carboxyl groups, can be used [paragraph [0051]). In contrast to the invention of the present application no monomers having cationic groups are used for producing the comb polymers. In this regard, paragraph [0051] only discloses that the anionic monomer may have a counter ion that is a cation such as a metal or ammonium ion.

US2010/0168282 A1 relates to comb polymers having cationic side chains. The comb polymers are produced using monomers in which a polyalkylene glycol side chain is connected with the main chain via an ester group (claim 1, paragraph [0034]). The comb polymers of the present application are structurally different from them because they have polyalkylene glycol side chains which are not linked to the main chain via ester groups.

Overall, it would be desirable to provide more dispersing agents which can be used in particular in clay-containing cement compositions in an efficient, variable and simple manner.

### THE OBJECT OF THE INVENTION

The object of the present invention is to overcome the disadvantages described above. The invention is therefore based on the problem to provide a simple, variable and efficient method for dispersion and liquefaction of hydraulically setting compositions and in particular of gypsum compositions. In particular, effective dispersing agents for clay-containing compositions are provided.

The dispersing agents should cause a high degree of liquefaction. They should also be effective over a long period of time and delay the setting of hydraulically setting compositions. In addition, dispersing agents are provided which make it possible to improve the effect of common polycarboxylate ethers.

Preferably, also the properties, and especially the stability of the cured products will be improved. In particular, an improvement in strength is achieved by reducing the water content.

### DISCLOSURE OF THE INVENTION

Surprisingly, the object underlying the invention is achieved by comb polymers, compositions, shaped bodies, methods and uses according to the claims. Further advantageous embodiments are disclosed in the description.

The subject matter of the invention is comb polymer obtainable by polymerizing a monomer mixture, which contains at least one monomer having at least one cationic group covalently bonded to the monomer and which contains at least one monomer of the formula

R¹—O-[AO]ₙ—R²,

wherein
R¹ is an alkenyl group,
R² represents H, an alkyl group having 1 to 20 C atoms, or an aryl group or alkylaryl group having 7 to 20 C atoms,
A independently of one another represents a C₂ to C₆ alkylene group,
in particular ethylene or propylene, wherein A is not an unbranched alkylene group having 4 or more C atoms,
   and n is a value from 2 to 300.

Hereinafter, the comb polymers according to the invention are also referred to as “cationic comb polymers”. The cationic comb polymer comprises cationic groups and can comprise additional anionic groups. The cationic polymer may therefore be a zwitterionic polymer. According to the invention the term “comb polymer” stands for the comb polymer or a salt thereof. Hence, a cationic comb polymer may be present in form of salts having suitable anions. The comb polymer is preferably a halide, in particular a chloride. However, it can also be present as sulfate, carbonate, acetate or other common salt. If the comb polymer is a zwitterion, it may be present as a salt with suitable anionic or cationic groups. The comb polymer may also be present as inner salt, in which its own cationic and anionic charges neutralize one another. If acid groups such as carboxyl groups are present, they may be partially or completely neutralized.

According to the invention, the cationic comb polymer comprises at least one cationic group at a portion of the side chains, and preferably a single cationic group per side chain. In this case not all the side chains in a polymer comprise cationic groups. The cationic group is covalently attached to the comb polymer. It may be a common cationic group which can be attached to organic polymers, in particular an ammonium, sulfonium or phosphonium group.

In a preferred embodiment of the invention, the cationic group is an ammonium group. Particularly preferably it is a quaternary ammonium group. In this case, a positively charged nitrogen atom is substituted with four organic radicals. Preferably, the cationic group has formula —N⁺R¹⁰R¹¹R¹², wherein R¹⁰, R¹¹ and R¹² are independently of one another H, an aliphatic hydrocarbon radical having 1 to 20 C atoms, a cycloaliphatic hydrocarbon radical having 5 to 8 C atoms and/or an aryl radical having 6 to 14 C atoms. Preferably, R¹⁰, R¹¹ and R¹² are not H, particularly preferably selected from methyl and ethyl.

In a preferred embodiment of the invention, the cationic group is part of a monomeric structural unit selected from [2-(acryloyloxy)-ethyl]trimethylammonium chloride, [2-(acryloylamino)-ethyl]trimethylammonium chloride, 2-(acryloyloxy)-ethyl]trimethylammoniummethosulfate, [2-(methacryloyloxy)-ethyl]trimethylammonium chloride or methosulfate, [3-(acryloylamino)-propyl]trimethylammonium chloride, [3-(methacryloylamino)-propyl]trimethylammonium chloride and diallyldimethylammonium chloride (DADMAC).

Particularly advantageous according to the invention proved to be the use of [2-(methacryloyloxy)-ethyl]trimethylammonium salts, in particular the chloride. The use is commercially available from Evonik Industries, DE (under the brand name “Visiomer TMAEMC”) or from Sigma-Aldrich, DE.

The cationic group is part of a side chain. This means that it is not part of the main chain of the comb polymer. Therefore, it does not connect subunits of the main chain to one another. Thereby it differs, for example, from condensates of dimethylamine and epichlorohydrin of US 2007/0287794 A1.

The monomer of formula R¹—O-[AO]ₙ—R² preferably has a radical -[AO]ₙ—, which is a polyethylene glycol or polypropylene glycol subunit. A represents ethylene of formula —C₂H₄— or propylene of formula —CH(CH₃)—CH₂—. If A has three or more C atoms, A is preferably branched and has the structure —CH(R′)—CH₂—, wherein R′ is preferably an alkyl group. In a preferred embodiment, the first radical A that is connected directly to R¹—O—, is not different from the other radicals A, and in particular not a “linker”, such as a linear butylene radical. Preferably, the entire group -[AO]ₙ— is a polymerization product. Variable n is preferably a value of 5 to 200, in particular between 10 and 150. As group -[AO]ₙ— is usually produced by polymerization, n denotes the average number of subunits -[AO]—.

Preferably, radical R¹ has a single double bond. Preferably, R¹ is an alkenyl group having 1 to 20, more preferably having 1 to 6 C atoms. In preferred embodiments, radical R¹ is selected from isoprenyl, allyl, isobutenyl, or vinyl. In this case, radical R¹ preferably has the structure CH₂═CH—CH₂— or CH₂═CH(CH₃)—CH₂—CH₂—.

R² is preferably H or an alkyl group having 1 to 6 C atoms.

In preferred embodiments, the monomer of formula R¹—O-[AO]ₙ—R² is an isoprenyl polyethylene glycol, allyl polyethylene glycol, isobutenyl polyethylene glycol, vinyl polyethylene glycol or in each case an ether thereof, wherein radical R² is preferably H or a C₁ to C₆ alkyl group. In this case, (isoprenyl polyethylene glycol)methyl ether, (allyl polyethylene glycol)methyl ether, (vinyl, polyethylene glycol)methyl ether, (isoprenyl polyethylene glycol)ethyl ether, (allyl polyethylene glycol)ethyl ether and (vinyl polyethylene glycol)ethyl ether are particularly preferred.

In a preferred embodiment, the comb polymer comprises acid groups, in particular carboxyl groups. The comb polymer is then a zwitterionic comb polymer. In this embodiment, the acid or carboxyl groups are preferably bonded directly to the main chain. Such a main chain is obtained when α-unsaturated carboxylic acid subunits, such as acrylic acid, methacrylic acid or substituted derivatives thereof, are used in the production by polymerization. Such monomers are common structural units of polycarboxylate ethers. Because of the close proximity to the main chain, the carboxyl groups are generally assigned to the main chain. Preferably, such a comb polymer is obtainable by polymerizing a monomer mixture containing an unsaturated carboxylic acid, in particular acrylic acid and methacrylic acid. In one embodiment of the invention, the main chain is a copolymer which contains acrylic acid and methacrylic acid as monomeric structural units. The carboxyl groups and the polycarboxylic acid may be present as free acid or as a salt, wherein only a part of the acid groups may be present as a salt. The polycarboxylic acid is then completely or partially neutralized. According to the invention, the term “salt” also comprises in addition to the classical salts obtained by neutralization with a base, complex compounds with metal ions and the carboxyl groups as ligands.

In a further preferred embodiment additionally monomeric structural units are included, which are esters or amides.

In the production of such polycarboxylic acids the chain length is regularly adjusted by means of a regulator, such as phosphite or sulfite.

Therefore, the polycarboxylic acids according to the invention may have groups that are not carboxylic acid units, such as phosphorus- or sulfur-containing groups such as phosphite- or sulfite-containing groups. Such groups are frequently attached terminally to the main chain and cap it.

In a preferred embodiment of the invention, the comb polymer comprises:
a) at least one structural unit A (cationic moiety), which preferably has formula (I)

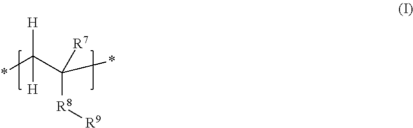

wherein
R⁷ independently of one another represents H or CH₃,
R⁸ independently of one another represents —CO—OR′—, —NH—R′—, —CO—NH—R′—, —O—, R′, —O—R′— or —R′—O—R′, wherein R′ is a C₁ to C₂₀ alkylene group which may be branched or unbranched, in particular a methylene, ethylene or propylene group, and
R⁹ independently of one another represents a cationic group;
containing optionally an appropriate anion such as chloride,
b) at least one structural unit B (ether unit) of formula (II):

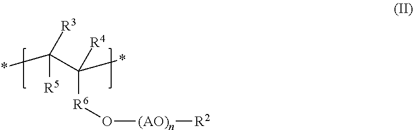

wherein
R² represents an H, an alkyl group having 1 to 20 C atoms, or an aryl or alkylaryl group having 7 to 20 C atoms,
A independently of one another represents a C₂ to C₆ alkylene group, wherein A is not an unbranched alkylene group having 4 or more C atoms,
R³, R⁴ and R⁵ are independently of one another selected from H and alkyl radicals having 1 to 20 C atoms, which may be linear, branched or cyclic
R⁶ is a C₁-C₆ alkylene group, in particular methylene,
n independently of one another is a value between 2 and 300,
c) optionally a structural unit C (acid moiety) of formula (III):

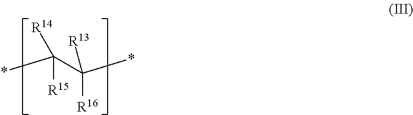

wherein each R¹³, R¹⁴ and R¹⁵ independently of one another represents H, —COOM, —CH₂COOM or an alkyl group having 1 to 5 carbon atoms,
R¹⁶ independently of one another represents —COOM, —CH₂COOM, —SO₂—OM, —O—PO(OM)₂ and/or —PO(OM)₂,
or wherein R¹⁵ and R¹⁶ form a ring —CO—O—CO—,
wherein M represents H, an alkali metal, an alkaline earth metal, ammonium, an ammonium cation, an organic ammonium compound or mixtures thereof;
with the proviso that overall a single or two of the radicals R¹³, R¹⁴, R¹⁵ and R¹⁶ are acid groups,
   wherein the structural unit C preferably is an acrylic acid unit or a salt thereof and/or a methacrylic acid unit or a salt thereof.

In preferred embodiments, the comb polymer may consist of structural units A and B, or consist of the structural units A, B and C. If the comb polymer overall has a charge, appropriate counterions, i.e., anions or cations, may be included.

Structural unit A is incorporated in a polymer according to the invention by using a cationic monomer, as described above, in the production by polymerization. The structure of structural unit B therefore corresponds to the monomers described above.

Structural unit B is incorporated in a polymer according to the invention by using a monomer of formula R¹—O-[AO]ₙ—R², as described above, in the production by polymerization. The structure of structural unit B therefore corresponds to the monomers described above.

In a preferred embodiment, the at least one structural unit B has formula (IIa):

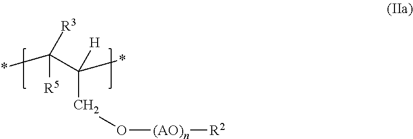

wherein
R² is H or an alkyl group having 1 to 6 C atoms,
A independently of one another represents an ethylene or propylene group,
R³ and R⁵ independently of one another are selected from H and alkyl radicals, which may be linear or branched, having from 1 to 6 C atoms and which are in particular methyl or ethyl, and
n independently of one another is a value between 5 and 200.

Structural unit C is usually introduced into the polymer by performing the polymerization in the presence of a corresponding acid monomer or a salt or anhydride thereof. Suitable acid monomers are in particular α-unsaturated mono- or dicarboxylic acids, in particular acrylic acid, methacrylic acid, maleic anhydride, maleic acid, itaconic acid, crotonic acid or fumaric acid.

The cationic comb polymer may additionally comprise at least one further structural unit D, which is different from structural units A, B and C. Such structural units D units may be selected from any of the common structural units for polycarboxylate ethers. If possible, they do not offset or affect the dispersing and plasticizing effect of the comb polymer. Preferably, structural unit D is selected from an ester, amide or imide unit, an acid unit selected from carboxylic acid, sulfonic acid, phosphonic acid, phosphoric acid esters, carbonylamidomethylpropanesulfonic acid and salts thereof, or a hydroxyethyloxycarbonyl, acetoxy, phenyl or N-pyrrolidonyl group. The structural unit D in particular can have formula (IV):

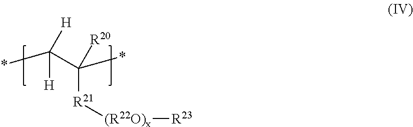

wherein
R²⁰ independently of one another represents H or CH₃;
R²¹ independently of one another represents an ester group —CO—O— or an amide group —CO—NH—;
R²² independently of one another represents a C₂-C₆ alkylene group, in particular an ethylene or propylene group,
R²³ independently of one another represents H, a C₁-C₁₂ alkyl or cycloalkyl radical, a C₇-C₂₀ alkylaryl or aralkyl radical, or a substituted or unsubstituted aryl radical, or a monovalent organic radical having 1 to 30 C atoms, which optionally comprises heteroatoms, and
x is independently of one another a value between 3 and 250, preferably between 5 and 150.

Suitable structural units D for incorporation into comb polymers are known in the prior art. They are described, for example, in EP 2 463 317 A1, which explicitly is incorporated herein by reference, in particular paragraphs [0022], [0023], [0026], and [0027].

The comb polymer may have any combination of the various structural units A and B, and optionally C and/or D. The sequence of the individual structural units may be alternating, random or blockwise.

In a preferred embodiment, the cationic comb polymer has no polyalkylene glycol units, which are connected to the main chain via ester groups. Preferably, at most structural units A comprise ester groups, but not the other structural units B, C and D.

In a preferred embodiment of the invention the comb polymer comprises at least 5 mol % or at least 15 mol % structural units A with side chains which have a cationic group, based on the total number of all monomeric structural units of the main chain of the comb polymer. In a preferred embodiment of the invention, the comb polymer comprises 5 to 95 mol %, preferably 15 to 85 mol % structural units A with side chains which have at least one cationic group, and 5 to 95 mol %, preferably 15 to 85 mol % structural units B, based on the total number of all monomeric structural units of the main chain of the comb polymer.

In a preferred embodiment of the invention, the sum of the structural units A with side chains having at least one cationic group and structural units B is at least 10 mol %, preferably at least 25 mol % or at least 40 mol %, and in one embodiment 100 mol %, each based on the total number of all monomeric structural units of the main chain of the comb polymer.

In a preferred embodiment, the comb polymer has 5 to 95 mol % structural units A, 5 to 95 mol % structural units B and 0 to 90 mol % structural units C, based in each case on the total number of all monomeric structural units in the main chain of the comb polymer. In addition, 0 to 50 mol % structural units D may be included. In this case, in a preferred embodiment, the sum of the monomeric structural units A, B and C is 100 mol %.

In a particularly preferred embodiment, the comb polymer comprises 15 to 40 mol % structural units A, 15 to 40 mol % structural units B and 40 to 80 mol % structural units C, based in each case on the total number of monomeric structural units in the main chain of the comb polymer. Such a polymer exhibits particularly good flowability. In addition, 0 to 20 mol % structural units D may be included.

The comb polymer preferably has an average molecular weight Mₙ from 400 to 100,000 g/mol, preferably from 500 to 70,000 g/mol, or from 750 to 40,000 g/mol, particularly preferably from 2,000 to 70,000 or from 5000 to 40,000.

The comb polymer comprises structural units B with polyether groups. Polyether groups are obtained by polymerization of alcohols having two or more hydroxyl groups such as ethylene glycol or propylene glycol. Preferably, the cationic comb polymer comprises a polyethylene glycol or polypropylene glycol component. In the prior art it is assumed that such polyether side chains improve the interaction of the comb polymers with the aqueous environment. They serve the hydrophilization of the comb polymers and contribute to the plasticizing effect. As far as variables n and x are given for the chain length in this application, they refer to the average number of subunits.

The invention also relates to a hydraulically setting composition containing a cationic comb polymer according to the invention and a hydraulically setting binder. The term “hydraulically setting composition” is understood to mean compositions that include hydraulically setting binders. Such binders are inorganic materials which cure in the presence of water. Suitable binders and compositions are known to those skilled in the field of construction chemicals. In a preferred embodiment of the invention the hydraulically setting binder in the composition is or comprises gypsum or cement or lime. Common cements are, for example, Portland cements or alumina cements and their respective mixtures with customary additives.

In a preferred embodiment of the invention, the hydraulically setting composition contains gypsum or the (only) hydraulically setting binder is gypsum. Gypsum is a synonym for calcium sulfate. Depending on the production method it can be present in various modifications, which differ by the content of water of crystallization and the crystalline form. Technically, use is made of the ability of gypsum to re-uptake water of crystallization that has been partially or completely removed by heating (firing) upon the addition of water, and to set in doing so. As processing requires more water than is necessary for setting, the surplus water (up to 65%) must be removed. Such a moist gypsum composition can be shaped. The gypsum may include calcium sulfate in different crystal forms, for example as β-hemihydrate, α-hemihydrate, anhydrite, or a mixture thereof. The gypsum may be natural gypsum or a product of smoke desulfurization plants (REA gypsum).

In a preferred embodiment of the invention, the hydraulically setting composition contains clay. Clays are products of weathering of feldspars. Upon dissolving out the alkali and alkaline earth metal components they consist of the remaining aluminum silicate. Common forms of clay are kaolinite, montmorillonite and bentonite. The clay content of the hydraulically setting binder such as gypsum or cement, may be, for example, between 0.1 and 15 wt. %, in particular between 0.2 and 10 wt. % or between 0.5 and 5 wt. %. Particularly preferably, the binder is a clay-containing gypsum. Natural gypsum can, depending on the deposit, contain a clay content.

The gypsum composition according to the invention preferably contains at least 15 wt. %, preferably at least 50 wt. %, still more preferably at least 70 wt. % or at least 95 wt. % clay-containing gypsum, based on the total weight. The clay-containing gypsum composition according to the invention may be anhydrous or contain less than 0.5, less than 1 or less than 5 wt. % water. However, it may also already contain up to 10, 20, 50 or 80 wt. % water. In a preferred embodiment, the proportion of the cationic comb polymer of a clay-containing gypsum composition is between 0.01 and 2 wt. %, in particular between 0.05 and 1 wt. %.

Optionally, the hydraulically setting composition contains additives. Suitably included are common additives such as fly ashes, silica fume, slag, blast furnace sands and limestone filler. Furthermore, aggregates such as sand, gravel, stones, quartz powder, chalks, or accelerators, corrosion inhibitors, retardants, shrinkage reducing agents, defoamers or pore formers can be used.

The cationic comb polymer is preferably used in an amount of 0.01 to 5 wt. %, in particular 0.05 to 2 wt. % or 0.1 to 1 wt. %, based on the weight of the hydraulically setting binder. The comb polymer may be added separately or as a comb polymer-containing composition in solid or liquid form. The comb polymer is preferably used in the form of a liquid composition, in particular as an aqueous solution.

The cationic comb polymer is used as a dispersing agent and thereby in particular as a plasticizer, as a water reducer, to improve the workability and/or to improve the flowability of the hydraulically setting compositions produced therewith, as well as to improve the stability of the cured products. In particular, according to the invention, hydraulically setting compositions can be obtained with extended workability. This means that following the addition of water and the comb polymer the composition is still workable for a long time, as compared to compositions not containing the comb polymer.

According to the invention, the flowability of a hydraulically setting composition is increased. By the addition of the cationic polymer, preferably, the slump is increased by at least 5%, in particular more than 10%, even more preferably by more than 15% or more than 25%, in each case compared to an identical composition without cationic polymer. The slump is determined here, for example, with a fluid sample containing 0.2 wt. % cationic comb polymer (based on the amount of the hydraulically setting binder), in particular after mixing with water and vigorous stirring for 30 seconds in a mini cone of 50 mm, filling height 51 mm, after 75 seconds. Here, the slump can be determined as described in the exemplary embodiments. Standard conditions according to DIN EN 132790-2 or DIN EN 12350-5—Testing fresh concrete—Part 5: Slump may be used as well.

The cationic comb polymer may be used as dispersing agents or as a component of a dispersing agent in conjunction with additional components. Other components may be other plasticizers such as polycarboxylate ethers (PCE), lignosulfonates, sulfonated naphthalene formaldehyde condensates or sulfonated melamine-formaldehyde condensates; or accelerators, retardants, shrinkage reducers, defoamers, air-entraining agents or foaming agents. Typically, the proportion of the comb polymer is 5 to 100 wt. %, in particular 20 to 100 wt. %, based on the total weight of the dispersing agent.

The cationic polymer comb or a comb polymer-containing composition can also be used in the solid state, for example as flakes, powders, scales, pellets, granules or plates. Such solid additives are easy to transport and store. In the solid state the comb polymer can be a component of a so-called dry mixture, for example a cement composition, which can be stored for a long time and is typically packaged and used in bags or stored in silos. Such a dry mixture can also be used after a long storage time and has good pourability.

The cationic comb polymer may be added to a hydraulically setting composition together with or shortly before or shortly after the addition of the water. Particularly suitable in this case has proven the addition of the comb polymer in the form of an aqueous solution or dispersion, in particular, as the mixing water, or as part of the mixing water. The aqueous solution is made in particular by subsequent mixing with water. However, the cationic comb polymer can be added to a hydraulically setting composition before or during milling, for example, cement clinker being milled to form cement.

In one embodiment of the invention the reaction product of the synthesis of the cationic comb polymer which was not further purified, is used as a dispersing agent. Because of the high concentration and stability of the comb polymers in these aqueous compositions purification is not necessarily required. Prior to use, however, further components can be added. In a further embodiment, the comb polymer may be purified prior to use as a dispersing agent, for example by removal of further components, for example by filtration.

In a preferred embodiment of the invention, the hydraulically setting composition includes at least one further dispersing agent. In this case, preferably a further comb polymer is used which has side chains with polyether groups which are bound to a main chain via ester, amide and/or ether groups, said main chains having carboxyl groups. Such comb polymers are also referred to as polycarboxylate ethers (PCE). In this case, the additional comb polymer is different from the cationic comb polymers according to the invention. Preferably, the further polycarboxylate ether has no cationic groups. According to the invention it has been found that it is particularly advantageous to use a common polycarboxylate ether having no cationic groups, together with a comb polymer according to the invention with cationic side chains. The proportion of polycarboxylate ethers and cationic comb polymers according to the invention may be, for example, between 1:10 and 10:1, in particular between 1:2 and 2:1. The combination of a cationic comb polymer according to the invention with a further polycarboxylate ether is particularly advantageous in clay-containing gypsum compositions. Without being bound by theory, in this case the cationic comb polymer could neutralize the clay particles and thereby the non-cationic polycarboxylate ether could develop the known plasticizing effect without being negatively impacted by the clay particles.

In a further embodiment of the invention no further dispersing agent and/or no further comb polymer is used in addition to the cationic comb polymers according to the invention.

The invention also relates to a shaped body obtainable by setting and curing of a hydraulically setting composition according to the invention. According to the invention “shaped body” designates any three-dimensional solid article which has received a shape, such as mobile design elements, parts of buildings, floors and coatings. Preferably, the shaped body is a gypsum board.

The invention also relates to the use of a cationic comb polymer according to the invention as a dispersing agent, in particular as a plasticizer for hydraulically setting compositions.

The invention also relates to a process for producing a cationic comb polymer according to the invention, comprising the steps of:

(A) providing a monomer mixture containing at least one monomer having at least one cationic group, and containing at least one monomer of the formula

R¹—O-[AO]ₙ—R²

wherein
R¹ is an alkenyl group,
R² represents H, an alkyl group having 1 to 20 C atoms, or an aryl or alkylaryl group having 7 to 20 C atoms,
A independently of one another represents a C₂ to C₆ alkylene group, wherein A is not an unbranched alkylene group having four or more C atoms,
and n is a value from 2 to 300, and
(B) polymerizing the monomer mixture to give the comb polymer.

Polymerization is preferably radical polymerization. Producing comb polymers from unsaturated monomers by radical polymerization per se is known in the prior art. In the polymerization, suitable auxiliaries such as initiators and regulators are used.

The comb polymers, compositions, shaped bodies, uses and methods according to the invention solve the problem on which the invention is based. According to the invention, new and efficient dispersing agents and plasticizers for hydraulically setting compositions are provided. The cationic comb polymers not only exhibit a strong plasticizing effect, but also significantly retard the setting and in doing so extend the workability. In particular, they neutralize the negative effects of clay in hydraulically setting compositions. Using the comb polymers according to the invention, the user can easily adjust and optimize the properties of hydraulically setting compositions.

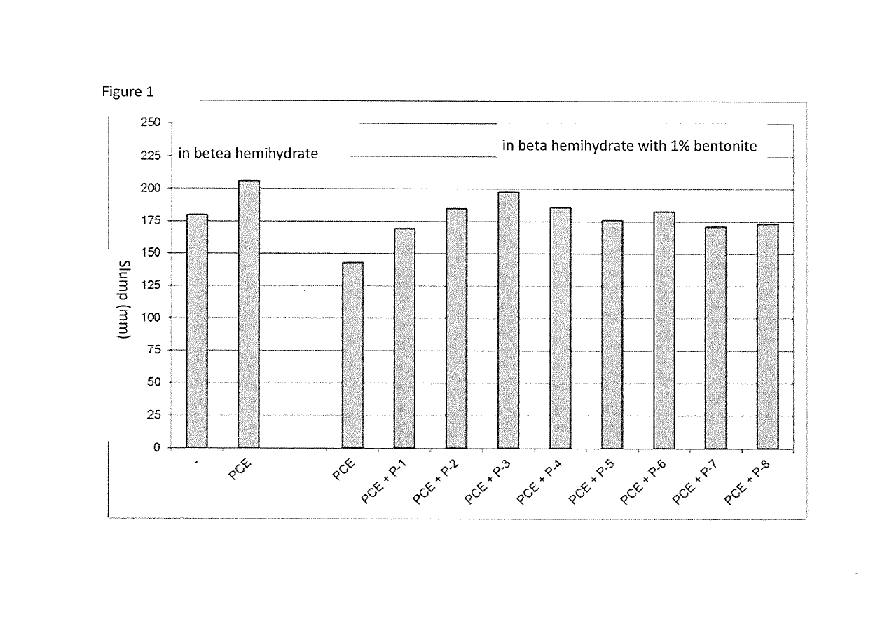

FIG. 1 shows an overview of the results of exemplary embodiments 9 to 19. For each experiment the slump in mm is plotted as shown in Table 2.

### EXEMPLARY EMBODIMENTS

### Examples 1 to 8

### Production of the Polymers

Polymer P-1 according to the invention was produced as follows. A reaction vessel equipped with a stirrer was charged with 240.0 g of T-PEG (isoprenyl PEG; trade name Oxab-501. Oxiranchem Inc., CN), 2.0 g of a 10% aqueous solution of Fe(II)—SO₄*7H₂O and 2.0 g of sodium hypophosphite (as regulator). Then, at a temperature of 25-50° C., 3.1 g of a 35% aqueous hydrogen peroxide solution, 27.7 g of TMAEMC (75% solution in water; trade name “Visiomer TMAEMC”, Evonik Industries, DE), and 1.7 g of a 5% aqueous solution of the initiator sodium hydroxymethylsulfinate (abbreviation NHMS; trade name “Rongalit”, BASF, Germany) were added dropwise through separate feeds over a period of 15 min with stirring. The reaction solution was cooled to avoid a rise in temperature>50° C., and after completion of the reaction it was stirred for additional 10-20 min to be free of peroxide.

Polymers P-2 to P-8 were produced according to the information given in Table 1 in the same manner as Polymer P-1. Allyl-PEG 1100 (trade name Polyglykol A 1100 Clariant, DE) and vinyl-PEG 1100 (trade name Polyglykol R 1100; Clariant, DE) were used also as monomers as indicated.

TABLE 1
Overview polymers P-1 to P-8; m = mol fraction of cationic monomer, n =
mol fraction of side chain, o = mol fraction of acrylic acid

| Ex. | Pol. | Mol % | Charge (g) | Feed (g) | Feed time |
|---|---|---|---|---|---|
| 1 | P-1 | m = 50 | 240.0 g T-PEG 2400 | 27.7 g TMAEMC, | 15 min |
| | | n = 50 | 2.0 g Fe(II)—SO₄*7H₂O | 3.1 g H₂O₂, | |
| | | o = 0 | 2.0 g Regulator | 1.7 g NHMS | |
| 2 | P-2 | m = 75 | 120 g T-PEG 2400 | 27.7 g TMAEMC | 20 min |
| | | n = 25 | 2.0 g Fe(II)—SO₄*7H₂O | 1.3 g H₂O₂ | |
| | | o = 0 | 2.1 g Regulator, 125 g H₂O | 0.8 g NHMS | |
| 3 | P-3 | m = 25 | 240 g T-PEG 2400 | 27.7 g TMAEMC | 20 min |
| | | n = 25 | 2.0 g Fe(II)—SO₄*7H₂O | 14.6 g Acrylic acid | |
| | | o = 50 | 2.0 g Regulator, 200 g H₂O | 2.7 g H₂O₂, 1.2 g NHMS | |
| 4 | P-4 | m = 33 | 240 g T-PEG 2400 | 27.7 g TMAEMC | 15 min |
| | | n = 33 | 2.0 g Fe(II)—SO₄*7H₂O | 7.2 g Acrylic acid | |
| | | o = 33 | 2.0 g Regulator, 200 g H2O | 2.3 g H₂O₂, 1.7 g NHMS | |
| 5 | P-5 | m = 40 | 240 g T-PEG 2400, | 27.7.1 g TMAEMC | 20 min |
| | | n = 40 | 2.0 g Fe(II)—SO₄*7H₂O, | 3.6 g Acrylic acid | |
| | | o = 20 | 2.0 g Regulator, 200 g H₂O | 2.3 g H₂O₂, 1.7 g NHMS | |
| 6 | P-6 | m = 50 | 110 g Allyl-PEG 1100, | 41.5 g TMAEMC | 15 min |
| | | n = 50 | 0.3 g Fe(II)—SO₄*7H₂O, | 5 g H₂O₂ | |
| | | o = 0 | 280 g H2O | 2 g NHMS | |
| 7 | P-7 | m = 20 | 60 g Vinyl-PEG 5800, | 2.8 g TMAEMC | 10 min |
| | | n = 20 | 0.2 g Fe(II)—SO₄*7H₂O, | 2.2 g Acrylic acid | |
| | | o = 60 | 0.2 g Regulator | 0.3 g H₂O₂ | |
| | | | | 0.3 g NHMS | |
| 8 | P-8 | m = 50 | 110 g Vinyl-PEG 1100, | 41.5 g TMAEMC | 15 min |
| | | n = 50 | 0.3 g Fe(II)—SO₄*7H₂O, | 5 g H₂O₂ | |
| | | 0 = 0 | 0.7 g Regulator, 280 g H₂O | 2 g NHMS | |

### Examples 9 to 19

### Production of Setting Gypsum Compositions and Characterization of Flowability

The slump value (ABM), the initial setting time (VB) and the final setting time (VE) of gypsum slurries (gypsum sludge cake) were determined as follows. First, the comb polymer (plasticizer) and the additive were added to 140 g of water. In this case, the amount of comb polymer or plasticizer was adjusted beforehand with regard to the amount of calcium sulfate. In the comparative experiments corresponding additives and/or comb polymer were/was omitted. Then, 200 g of calcium sulfate β hemihydrate and 0.2 g of calcium sulfate dihydrate were interspersed within 15 seconds in the water and the gypsum slurry allowed to soak for 15 seconds. The mixture was then stirred vigorously by hand for 30 seconds. The mini cone with a diameter of 50 mm and a height of 51 mm was filled and the slump (ABM) in millimeters was determined after 75 seconds. The diameter of the forming gypsum cake was measured once no more flowing was observed. The diameter in mm was designated as slumps. The initial setting time and final setting time were determined by the knife-cut method according to DIN EN 13279-2 and the thumb pressure method. The initial setting time (VB) is reached when, after a knife cut through the gypsum cake the cut edges no longer converge. The final setting time (VE) has occurred when upon finger pressure at a pressure of about 5 kg no more water emerges from the gypsum cake. To set the clay content accurately and reproducibly, a set amount of clay was added to pure calcium sulfate. A calcium sulfate β hemihydrate together with calcium sulfate dihydrate was used as gypsum and bentonite (Sigma-Aldrich Chemie GmbH, Switzerland) was added.

The experimental conditions and the results are summarized in Table 2. Non-inventive examples are categorized as “V” (comparison). For comparison and testing of combinations, common polycarboxylate ethers with no cationic side chains (“PCE”; trade name Sika ViscoCrete G2; Sika, CH) were used. The result is also shown graphically in FIG. 1. The examples show that the flowability of clay-containing gypsums can be significantly increased by addition of the comb polymers according to the invention. In addition, the initial setting time can be delayed significantly.

TABLE 2
Summary of experimental conditions and results

| | | | β hemi | | | | | | | |
|---|---|---|---|---|---|---|---|---|---|---|
| | | Bentonite | hydrate | Non-cationic polymer | | Cationic polymer | | ABM | VB | VE |
| Example | Type | % | % | Name | Dos. % | | Dos. % | [mm] | [min:s] | [min:s] |
| 9 | V | 0.0% | 100.0% | — | 0.00 | | 0.00 | 180 | 02:50 | 06:50 |
| 10 | V | 0.0% | 100.0% | PCE | 0.20 | | 0.00 | 206 | 04:40 | 12:40 |
| 11 | V | 1.0% | 99.0% | PCE | 0.20 | | 0.00 | 143 | 02:50 | 09:05 |
| 12 | | 1.0% | 99.0% | PCE | 0.20 | P-1 | 0.20 | 169 | 03:20 | 09:35 |
| 13 | | 1.0% | 99.0% | PCE | 0.20 | P-2 | 0.20 | 185 | 04:00 | 09:50 |
| 14 | | 1.0% | 99.0% | PCE | 0.20 | P-3 | 0.20 | 198 | 04:00 | 10:40 |
| 15 | | 1.0% | 99.0% | PCE | 0.20 | P-4 | 0.20 | 186 | 04:00 | 09:55 |
| 16 | | 1.0% | 99.0% | PCE | 0.20 | P-5 | 0.20 | 176 | 03:55 | 09:45 |
| 17 | | 1.0% | 99.0% | PCE | 0.20 | P-6 | 0.20 | 183 | 04:50 | 11:27 |
| 18 | | 1.0% | 99.0% | PCE | 0.20 | P-7 | 0.20 | 171 | 03:30 | 10:30 |
| 19 | | 1.0% | 99.0% | PCE | 0.20 | P-8 | 0.20 | 173 | 04:05 | 11:58 |

1. A comb polymer obtainable by polymerizing a monomer mixture, which contains at least one monomer having at least one cationic group covalently bonded to the monomer and which contains at least one monomer of the formula
R¹—O-[AO]ₙ—R²,
wherein
R¹ is an alkenyl group,
R² represents H, an alkyl group having 1 to 20 C atoms, or an aryl group or alkylaryl group having 7 to 20 C atoms,
A independently of one another represents a C₂ to C₆ alkylene group, wherein A is not an unbranched alkylene group having 4 or more C atoms,
and n is a value from 2 to 300.

2. The comb polymer of claim 1, wherein said at least one cationic group is a quaternary ammonium group.

3. The comb polymer according to claim 1, wherein the cationic group has the formula —N⁺R¹⁰R¹¹R¹², wherein R¹⁰, R¹¹ and R¹² independently of one another are H, an aliphatic hydrocarbon radical having 1 to 20 C atoms, a cycloaliphatic hydrocarbon radical having 5 to 8 C atoms and/or an aryl group having 6 to 14 C-atoms.

4. The comb polymer according to claim 1, wherein the monomer having at least one cationic group is selected from [2-(acryloyloxy)-ethyl]trimethylammonium chloride, [2-(acryloylamino)-ethyl]trimethylammonium chloride, 2-(acryloyloxy)-ethyl]trimethylammoniummethosulfate, [2-(methacryloyloxy)-ethyl]trimethylammonium chloride or methosulfate, [3-(acryloylamino)-propyl]trimethylammonium chloride, [3-(methacryloylamino)-propyl]trimethylammonium chloride and diallyldimethylammonium chloride (DADMAC).

5. The comb polymer according to claim 1, wherein the monomer of the formula R¹—O-[AO]ₙ—R² is an isoprenyl polyethylene glycol, allyl polyethylene glycol or vinyl polyethylene glycol, wherein radical R² is H or a C₁ to C₆ alkyl group.

6. The comb polymer according to claim 1, wherein the comb polymer has carboxyl groups.

7. The comb polymer according to claim 1, comprising
a) at least one structural unit A, which has formula (I) 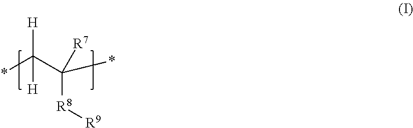
wherein
R⁷ independently of one another represents H or CH₃,
R⁸ independently of one another represents —CO—OR′—, —NH—R′—, —CO—NH—R′—, —O—, R′, —O—R′— or R′—O—R′, wherein R′ is a C₁ to C₂₀ alkylene group which may be branched or unbranched, and
R⁹ independently of one another represents a cationic group;
b) at least one structural unit B of formula (II): 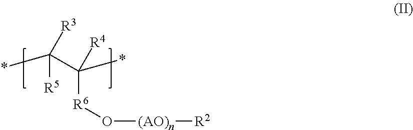
wherein
R² represents an H, an alkyl group having 1 to 20 C atoms, or an aryl or alkylaryl group having 7 to 20 C atoms,
A independently of one another represents a C₂ to C₆ alkylene group, wherein A is not an unbranched alkylene group having 4 or more C atoms,
R³, R⁴ and R⁵ are independently of one another selected from H and alkyl radicals having 1 to 20 C atoms, which may be linear, branched or cyclic
R⁶ is a C₁-C₆ alkylene group,
n independently of one another is a value between 2 and 300.
c) optionally a structural unit C of formula (III): 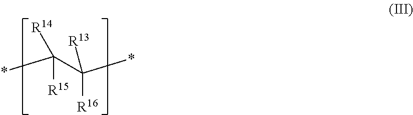
wherein each R¹³, R¹⁴ and R¹⁵ independently of one another represents H, —COOM, —CH₂COOM or an alkyl group having 1 to 5 carbon atoms,
R¹⁶ independently of one another represents —COOM, —CH₂COOM, —SO₂—OM, —O—PO(OM)₂ and/or —PO(OM)₂,
or wherein R¹⁵ and R¹⁶ form a ring —CO—O—CO—,
wherein M represents H, an alkali metal, an alkaline earth metal, ammonium, an ammonium cation, an organic ammonium compound or mixtures thereof;
with the proviso that overall a single or two of the radicals R¹³, R¹⁴, R¹⁵ and R¹⁶ are acid groups,
wherein the structural unit C is an acrylic acid unit or a salt thereof and/or a methacrylic acid or a salt thereof.

8. The comb polymer according to claim 7, wherein the at least one structural unit B has formula (IIa): 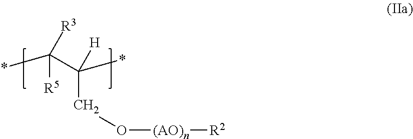
wherein
R² is H or an alkyl group having 1 to 6 C atoms,
A independently of one another represents an ethylene or propylene group,
R³ and R⁵ independently of one another are selected from H and alkyl radicals, which may be linear or branched, having from 1 to 6 C atoms, and
n independently of one another is a value between 5 and 200.

9. The comb polymer according to claim 7, wherein the comb polymer has 5 to 95 mol % structural units A, 5 to 95 mol % structural units B and 0 to 90 mol % structural units C, based in each case on the total number of all monomeric structural units in the main chain of the comb polymer, wherein the sum of the monomeric structural units A, B and C is 100 mol %.

10. A hydraulically setting composition containing a comb polymer according to claim 1 and a hydraulically setting binder.

11. The hydraulically setting composition according to claim 10, which additionally contains clay.

12. The hydraulically setting composition according to claim 10, which additionally contains at least one polycarboxylate ether having no cationic groups.

13. A shaped body obtainable by setting and curing of a hydraulically setting composition according to claim 10.

14. A method comprising: providing a comb polymer according to claim 1 as a dispersing agent for hydraulically setting compositions.

15. A process for producing a comb polymer according to claim 1, comprising the steps of:
(A) providing a monomer mixture, and
(B) polymerizing the monomer mixture to give the comb polymer.
